(19) United States
(12) Patent Application Publication
(10) Pub. No.: US 2012/0087135 A1
(43) Pub. Date: Apr. 12, 2012

(54) Lamp Shade Structure

(76) Inventor: Cheng-Ron Chan, Tainan City (TW)

(21) Appl. No.: 12/898,791

(22) Filed: Oct. 6, 2010

(51) Int. Cl. F21V 7/00

(52) U.S. Cl. 362/341

(57) ABSTRACT

A lamp shade structure includes a shade body for being mounted by a light emitting member. The shade body includes first and second ends spaced in a width direction perpendicular to a longitudinal axis of the light emitting member. The shade body further includes an inner surface having a convex upper end. The inner surface includes a first reflecting surface between the first end and the upper end of the inner surface and a second reflecting surface between the second end and the upper end of the inner surface. A length of the first reflecting surface in the width direction is larger than a length of the second reflecting surface in the width direction so that the light emitting member can generate optical beams of unsymmetrical illuminance distribution, and that the effect of increasing beam angle and expanding illumination range can then be achieved.

### BACKGROUND OF THE INVENTION

1. Field of the Invention

The present invention relates to a lamp shade structure and, more particularly, to a lamp shade that allows a light emitting member mounted in the lamp shade to generate optical beam of unsymmetrical illuminance distribution.

2. Description of the Related Art

A conventional lamp generally includes a light emitting member and a lamp shade to focus optical beams of the light emitting member. An inner surface of the lamp shade is usually provided with a reflecting layer to reflect or refract the optical beams of the light emitting member, and the illumination can then be brighter.

FIG. 1 shows a conventional lamp 10 including a lamp shade 11 and a light emitting member (a lamp tube) 12 mounted inside the lamp shade 11. Lamp shade 11 includes an inner surface 111 for reflecting optical beams generated by the light emitting member 12. The inner surface 111 has arcuate cross sections and includes first and second ends 112 and 113 spaced in a width direction. Light emitting member 12 is arranged in a center between first and second ends 112 and 113 of inner surface 111 in the width direction so that light emitting member 12 can emit optical beams of symmetrical illuminance distribution. Specifically, a spacing A1 between the center of light emitting member 12 and first end 112 of inner surface 111 in the width direction is the same as a spacing A2 between the center of light emitting member 12 and second end 113 of inner surface 111 in the width direction. Thus, the optical beams of light emitting member 12, after the reflection from the inner surface 111 of lamp shade 11, can be focused. However, the light emitting member 12 is of symmetrical arrangement relative to the first and second ends 112 and 113 of inner surface 111 of lamp shade 11, resulting in the drawbacks of a small beam angle and narrow illumination range.

### BRIEF SUMMARY OF THE INVENTION

Therefore, it is an objective of the present invention to overcome the aforementioned shortcoming and deficiency of the prior art by providing a lamp shade structure that can increase beam angles and expand the illumination range.

To achieve the foregoing objective, a lamp shade structure of the present invention includes a shade body adapted to be mounted by a light emitting member. The shade body includes two side edges spaced along a longitudinal axis of the light emitting member. The lamp shade further includes a supporting portion extending downwards from each of the side edges for supporting the light emitting member. The shade body further includes first and second ends spaced in a width direction perpendicular to the longitudinal axis, with the first and second ends of the shade body and lower ends of the supporting portions together defining an opening. The shade body further includes an inner surface facing the opening and having a convex upper end. The inner surface further includes a first reflecting surface between the first end and the upper end of the inner surface and a second reflecting surface between the second end and the upper end of the inner surface. The length of the first reflecting surface in the width direction is larger than the length of the second reflecting surface in the width direction so that the light emitting member can generate optical beams of unsymmetrical illuminance distribution.

In a preferred form, the inner surface of the shade body has arcuate cross sections, and the upper end of the inner surface of the shade body is aligned with the light emitting member in a direction perpendicular to the longitudinal axis and the width direction.

Preferably, the length of the first reflecting surface in the width direction is two times the length of the second reflecting surface in the width direction.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a cross sectional view of a conventional lamp shade.

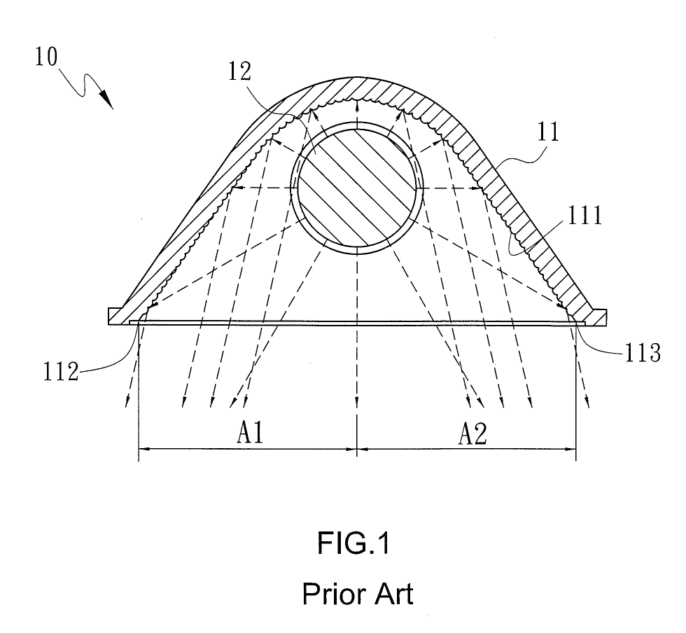

FIG. 2 shows a perspective view of a lamp shade according to the preferred teachings of the present invention.

FIG. 3 shows a front view of the lamp shade of FIG. 2 with a lamp tube mounted in the lamp shade.

FIG. 4 shows a cross sectional view of the lamp shade of FIG. 2 taken along plane 4-4 in FIG. 3.

FIG. 5 illustrates reflected optical beam angles of the lamp tube of FIG. 4 as reflected by the lamp shade of FIG. 4.

### DETAILED DESCRIPTION OF THE INVENTION

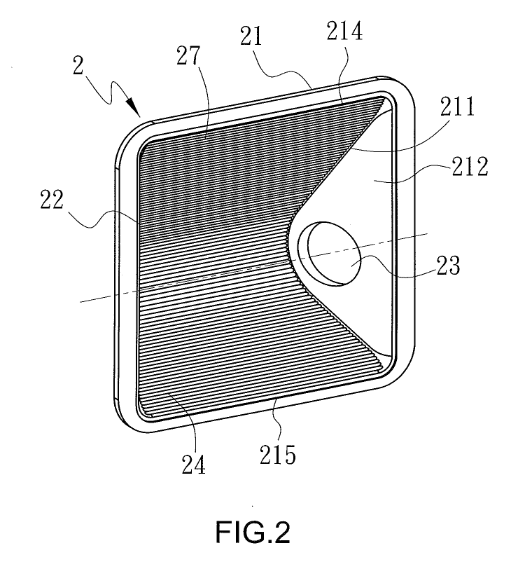

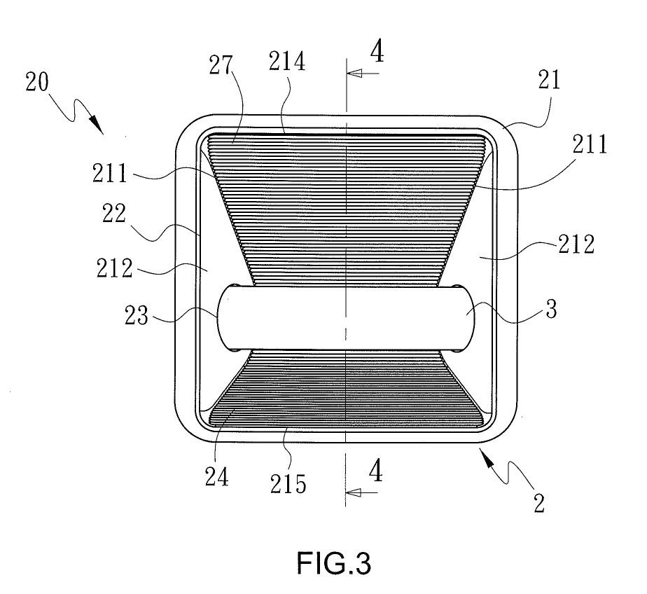

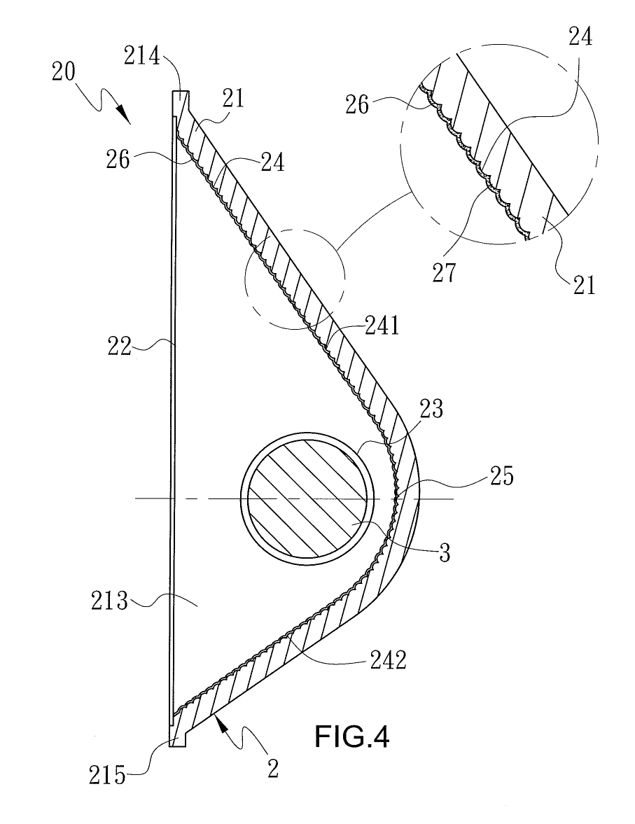

A lamp shade according to the preferred teachings of the present invention is shown in FIGS. 2 through 5 of the drawings and generally designated 2. A light emitting member 3 can be mounted in the lamp shade 2 to form a lamp 20. In this embodiment, the light emitting member 3 is a lamp tube.

The lamp shade 2 includes an arcuate shade body 21 having two side edges 211 spaced along a longitudinal axis of the light emitting member 3. A supporting portion 212 extends downwards from each side edge 211 to support the light emitting member 3. Supporting portions 212 and shade body 21 together define a receiving space 213 for receiving the light emitting member 3. Each supporting portion 212 includes a through-hole 23 in which one of two ends of light emitting member 3 is mounted. Shade body 21 further includes first and second ends 214 and 215 spaced in a width direction perpendicular to the longitudinal axis. First and second ends 214 and 215 and lower ends of supporting portions 212 together define an opening 22. Further, the shade body 21 includes an inner surface 24 facing the opening 22. In this embodiment, shade body 21 is made up of high temperature resistant glass, and a light reflecting mirror layer 26 is provided on inner surface 24 to reflect optical beams generated by the light emitting member 3. Furthermore, inner surface 24 is provided with optical design of a plurality of protruding portions 27 extending along the longitudinal axis so that the effect of reflecting the optical beams of light emitting member 3 can be further increased.

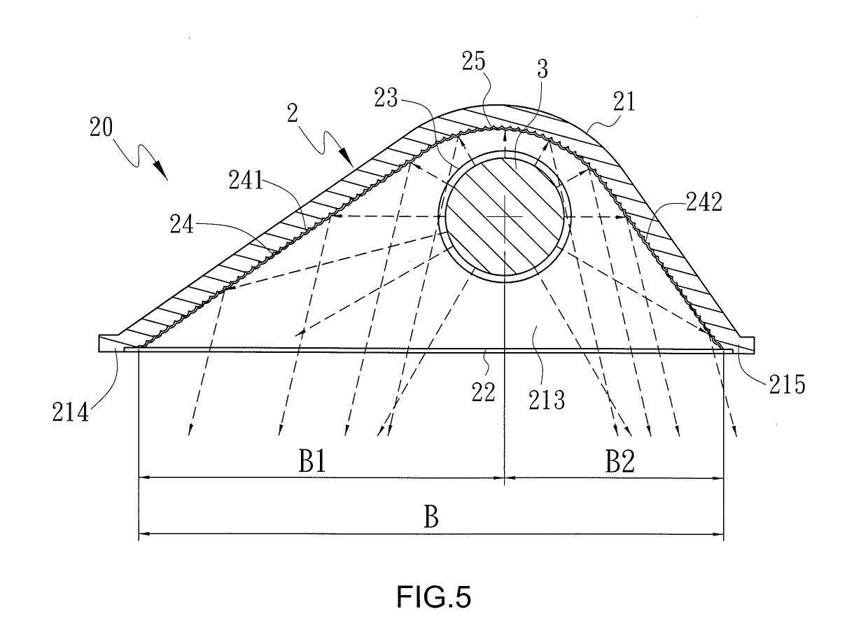

According to the preferred form shown, inner surface 24 of shade body 21 has parabolic cross sections and includes a convex upper end 25. In this embodiment, the convex upper end 25 of inner surface 24 of shade body 21 is aligned with the light emitting member 3 in a direction (a vertical direction in FIG. 5) perpendicular to the longitudinal axis and the width direction. Inner surface 24 further includes a first reflecting surface 241 between first end 214 and the upper end 25 of inner surface 24 and a second reflecting surface 242 between second end 215 and the upper end 25 of inner surface 24. Moreover, a length of first reflecting surface 241 in the width direction is larger than a length of second reflecting surface 242 in the width direction so that the light emitting member 3 can generate optical beams of unsymmetrical illuminance distribution. According to the preferred form shown, the length B1 of first reflecting surface 241 in the width direction (namely, the spacing between a center of light emitting member 3 and the first end 214 of shade body 21 in the width direction) is two times the length B2 of second reflecting surface 242 (namely, the spacing between the center of light emitting member 3 and the second end 215 of shade body 21 in the width direction). In other words, the length B1 of first reflecting surface 241 in the width direction is ⅔ of the total length B of inner surface 24 in the width direction, and the length B2 of second reflecting surface 242 in the width direction is ⅓ of the total length of inner surface 24 in the width direction. With the length ratio of first reflecting surface 241 to second reflecting surface 242 in the width direction, the light emitting member can generate optical beams of unsymmetrical illuminance distribution, and the effect of increasing beam angle and expanding illumination range can then be achieved.

Now that the basic teachings of the present invention have been explained, many extensions and variations will be obvious to one having ordinary skill in the art. For example, the ratio between the length of first reflecting surface 241 of shade body 21 in the width direction and the length of second reflecting surface 242 of shade body 21 in the width direction can be 3:1 or 3:2. However, the optimal length ratio is 2:1. That is, the length B1 of first reflecting surface 241 in the width direction is two times the length B2 of second reflecting surface 242 in the width direction. Thereby, the beam angle and the illumination range provided by the light emitting member 3 can be optimized.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A lamp shade structure comprising a shade body adapted to be mounted by a light emitting member, with the shade body including two side edges spaced along a longitudinal axis of the light emitting member, with the lamp shade further comprising a supporting portion extending downwards from each of the side edges for supporting the light emitting member, with the shade body further including first and second ends spaced in a width direction perpendicular to the longitudinal axis, with the first and second ends of the shade body and lower ends of the supporting portions together defining an opening, with the shade body further including an inner surface facing the opening, with the inner surface of the shade body including a convex upper end, with the inner surface further including a first reflecting surface between the first end and the upper end of the inner surface and a second reflecting surface between the second end and the upper end of the inner surface, with a length of the first reflecting surface in the width direction being larger than a length of the second reflecting surface in the width direction so that the light emitting member can generate optical beams of unsymmetrical illuminance distribution.

2. The lamp shade structure according to claim 1, with the inner surface of the shade body having arcuate cross sections, and with the upper end of the inner surface of the shade body aligned with the light emitting member in a direction perpendicular to the longitudinal axis and the width direction.

3. The lamp shade structure according to claim 2, with the length of the first reflecting surface in the width direction being two times the length of the second reflecting surface in the width direction.

4. The lamp shade structure according to claim 3, with the inner surface of the shade body further including a light reflecting mirror layer, and with the inner surface of the shade body provided with a plurality of protruding portions extending along the longitudinal axis.

5. The lamp shade structure according to claim 4, with the supporting portions and the shade body together defining a receiving space for receiving the light emitting member, and with each of the supporting portions including a through-hole in which one of two ends of light emitting member is mounted.

6. The lamp shade structure according to claim 1, with the length of the first reflecting surface in the width direction being two times the length of the second reflecting surface in the width direction.

7. The lamp shade structure according to claim 6, with the inner surface of the shade body further including a light reflecting mirror layer, and with the inner surface of the shade body provided with a plurality of protruding portions extending along the longitudinal axis.
